(19) United States
(12) Patent Application Publication
(10) Pub. No.: US 2007/0034720 A1
(43) Pub. Date: Feb. 15, 2007

(54) Spray head for high-pressure abrasive blasting applications

(76) Inventors: Martin Oberscheidt, Ennigerloh (DE); Deszoe Schilling, Hemmingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/551,287

(22) PCT Filed: Feb. 14, 2004
(86) PCT No.: PCT/EP04/01399

§ 371 Date: Aug. 23, 2006

(30) Foreign Application Priority Data
Mar. 28, 2003 (DE) 103 14 022.0

(51) Int. Cl. A62C 31/02; B05B 1/04; B05B 1/00

(52) U.S. Cl. 239/589; 239/600; 239/594

(57) ABSTRACT

A spray head for high-pressure jet applications includes a nozzle carrier and at least one exchangeable nozzle disposed in a bore of the nozzle carrier, which exchangeable nozzle is sealed along an annular surface against the wall of the bore. In order to render the spray head more suitable for pressures in excess of 2000 bar, the bore, at the region against which the exchangeable nozzle directly bears—hereinafter more simply referred to as the bore bottom—is conically configured. Furthermore, the exchangeable nozzle, in the region of the bore bottom—hereinafter more simply referred to as the nozzle seat—is likewise conically configured. In addition, in the installed, functional state, the nozzle seat, along an annular line, bears directly and in a sealing manner against the bore bottom.

This invention relates to a spray head for high-pressure jet applications, comprising a nozzle carrier and at least one exchangeable nozzle disposed in a bore of the nozzle carrier and preferably configured as a flat spray nozzle, the exchangeable nozzle being sealed along an annular surface against the wall of the bore. One example of this type of spray head is known from U.S. Pat. No. 5,512,318.

A process which is used for the preparation of a surface, which surface is designated for the subsequent application of a thermally sprayed coating, is known from U.S. Pat. No. 5,512,318. In this process, a liquid is forced through a flat spray nozzle of a spray head, which nozzle is disposed in a changeable manner in a nozzle carrier of the spray head. The spray head is guided at a distance of between 6.2 mm and 50 mm to the surface and the fanned-out liquid jet is directed onto the surface at a pressure in excess of 2068 bar. With this, the surface is swept down with the liquid jet and is uniformly roughened.

After some time, the exchangeable nozzle is spent, with the result that it has to be changed. To this end, the nozzle carrier contains a bore in which the exchangeable nozzle is disposed. The nozzle has a sealing ring, which is made, in particular, of an elastomer and which, especially in use, attaches itself to the wall of the bore and in this way forms a sealing annular surface.

If a spray head of this type is operated at pressures in excess of 2000 bar, the spray head begins leaking after a relatively short time, with the result that the exchangeable nozzle then has to be changed. The service life of the spray head is therefore very short and unfavorable for mass production. Furthermore, due to design factors, the sealing with an elastomer element calls for additional constructional length of the nozzle in order to accommodate the seal. Usage with optimal distances to the sprayed surface in cramped conditions is thereby rendered impossible or is restricted (see appended digital photo comparison).

An object of the invention is to refine the nozzle carrier such that, at the very least, its service life is increased and a more compact construction is achieved.

This object is achieved with a spray head having direct and seal-effective metallic contact of the nozzle seat against the wall of the bore of the nozzle carrier. As a result of this contact, the sealing effect in this region is improved, and the spray head can be operated for longer and is more compact. Furthermore, at least the exchangeable nozzle is made of a steel, preferably a high-quality steel, and especially preferably of an aircraft and/or spacecraft material.

Refinements of the spray head are apparent from the dependent claims. Otherwise, the invention is explained in greater detail with reference to the illustrative embodiments represented in the drawings.

### BRIEF DESCRIPTION OF THE DRAWINGS

FIG. 1 shows a detail of a spray head,

FIG. 2 shows an exploded representation of a part-region of the spray head according to FIG. 1,

FIG. 3 shows an exchangeable nozzle disposed in a nozzle carrier, and

FIG. 4 shows a cross section of a nozzle seat and bore bottom.

### DETAILED DESCRIPTION OF THE INVENTION

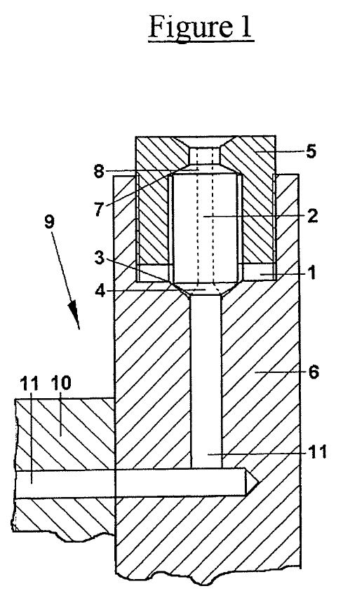

In FIG. 1, a detail of a spray head 9 for high-pressure jet applications is represented, which is particularly suitable for pressures above 2000 bar, preferably between 2000 bar and 4000 bar, especially at about 3000 bar.

The spray head 9 has a nozzle carrier 6 and a carrier holder 10 on which the nozzle carrier 6 is disposed. The carrier holder 10, for its part, is mounted such that it can both be rotated about its longitudinal axis and transported along it. Within the carrier holder 10 and the nozzle holder 6 there are provided supply bores 11 for the fluid to be sprayed.

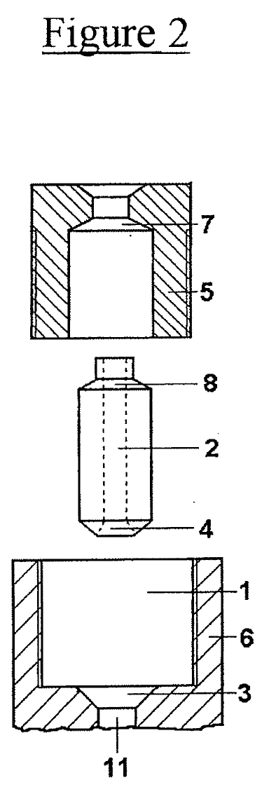

On the outer periphery, the nozzle carrier 6 has at least one exchangeable nozzle 2. The exchangeable nozzle 2 is disposed in a bore 1 of the nozzle carrier 6, the bore axis of which is aligned toward the midpoint of the nozzle carrier 6. Furthermore, the exchangeable nozzle is fluidically connected to the associated supply bore 11 of the nozzle carrier 6. For easier identification of the individual components, that region of the spray head 9 in which the exchangeable nozzle 2 is disposed in the bore 1 is represented in FIG. 2 as an exploded representation.

The replaceable exchangeable nozzle 2 is pressed by means of a holding screw 5 against the bore bottom 3 of the bore 1, whereby the assigned region of the exchangeable nozzle 2—hereinafter referred to as the nozzle seat 4—bears directly against the bore bottom 3. The holding screw 5 can hence be used to set a precisely defined contact pressure of the exchangeable nozzle 2 against the bore bottom 3.

In addition, as a result of this pressurized direct metallic contact of the nozzle seat 4 against the bore bottom 3, an annular surface is formed which over a very long period is always seal-effective, even at very high pressures up to at least 4000 bar.

This good sealing effect is achieved, inter alia, by the fact that both the bore bottom 3 and the nozzle seat 4 are conically configured.

Sensibly, the included angle of the bore bottom 3 is greater than the corresponding flank angle of the nozzle seat 4, thereby ensuring a good contact of the nozzle seat 4 against the bore bottom 3.

Expediently, the flank angle and the included angle therefore differ from one another by no more than about 5°, preferably by no more than about 3°, and especially preferably by no more than about 1°.

For production engineering and sealing-related reasons, a flank angle of the nozzle seat 4 of about 58° and an included angle of the bore of about 60° have proved particularly favorable.

To enable the exchangeable nozzle 2 to be centered in a simple, rapid and reliable manner relative to the supply bore 11, the shape of the cross-sectional area of the nozzle seat 4 is configured in accordance with the shape of the cross-sectional area of the bore bottom 3. In order to ensure twist-proofness and positional locking and hence alignment of the flat jet, the corresponding cross-sectional areas differ from a circular form. In particular, the cross-sectional areas—as represented in FIG. 4—have a circular form with circular arc segments 12 spaced apart in parallel. This positional locking is preferably provided in front of the sealing edge on the pressure side, i.e. upstream in the direction of flow. This produces a compact and space-saving construction with small dimensions which allow the spray head to be used in inner bores of small diameter.

As already mentioned, the exchangeable nozzle 2 is held in the installed state in the bore 1 by means of an external holding screw 5. The holding screw 5 surrounds the exchangeable nozzle on the outside and end side and is screwed to the wall of the bore 2 of the nozzle carrier 6.

A good press-fit and adjustment of the exchangeable nozzle 2 is realized, in particular, by the fact that the holding screw 5, at the region against which the exchangeable nozzle 2, in particular, directly bears—hereinafter more simply referred to as the screw bottom 7—is conically configured. In addition, the exchangeable nozzle 2, in the region of the screw bottom 7—hereinafter more simply referred to as the screw seat 8—is, analogously, likewise of correspondingly conical configuration.

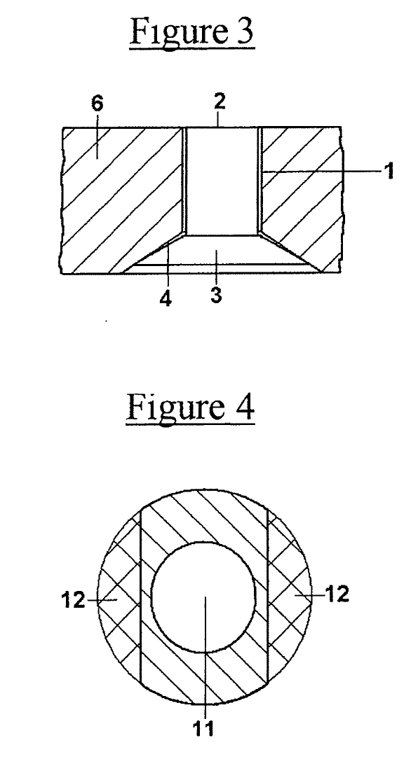

FIG. 3 shows a further basic embodiment of the exchangeable nozzle 2 and of the bore 1 of a nozzle carrier 6. In this case, the exchangeable nozzle 2 is configured in the style of a countersunk screw having a, in longitudinal section, trapezoidal head and a cylindrical shaft. Along its cylindrical shaft, the exchangeable nozzle 2 has an external thread, which is screwed into a corresponding internal thread of the bore 1. The conical region of the exchangeable nozzle 2, i.e. the nozzle seat 4, also forms with the corresponding bore bottom 3 a fully circumferential and seal-effective annular surface.

An exchangeable nozzle 2 of this type can be facing, with its conical region, both toward the inflow direction of the pressurized fluid and away from the inflow direction.

If the conical region of the exchangeable nozzle is turned toward the direction of flow, the replacement of the nozzle is made more difficult, but the exchangeable nozzle 2 can then additionally be forced by the fluid against the bore bottom 3 and the sealing effect improved.

If the conical region of the exchangeable nozzle, on the other hand, is aligned counter to the direction of flow, the exchangeable nozzle has to be more firmly tightened, but, in return, the replacement of the nozzle is made easier.

Contrary to the illustrative embodiment which is represented here, it is similarly sensible to fasten the exchangeable nozzle 2 to the nozzle carrier 6 with a holding screw (not represented) having an internal thread. The holding screw is not then screwed into the nozzle carrier 6, but instead, for example, is slipped over a dome of the nozzle carrier 6 and screwed onto the outer periphery of the dome which receives the exchangeable nozzle.

1-8. (canceled)

9. A spray head for high-pressure jet applications, comprising:
a nozzle carrier, and
at least one exchangeable nozzle disposed in a bore of the nozzle carrier and sealed along an annular surface against the wall of the bore,
wherein the bore, at a bore bottom against which the exchangeable nozzle directly bears, is conically configured,
wherein the exchangeable nozzle, at a nozzle seat in the region of the bore bottom, is likewise conically configured, and
wherein, in an installed, functional state, the nozzle seat, along the annular surface, bears directly and in a sealing manner against the bore bottom.

10. The spray head as claimed in claim 9, wherein the bore bottom has an included angle greater than a corresponding flank angle of the nozzle seat.

11. The spray head as claimed in claim 10, wherein the flank angle differs from the included angle by no more than about 5°.

12. The spray head as claimed in claim 10, wherein the flank angle of the nozzle seat measures about 58° and the included angle of the bore bottom measures about 60°.

13. The spray head as claimed in claim 9, wherein, for positional locking of the exchangeable nozzle in the nozzle carrier, the cross-sectional area of the nozzle seat has a shape which corresponds to a shape of the cross-sectional area of the bore bottom, and wherein the cross-sectional areas are non-circular.

14. The spray head as claimed in claim 13, wherein the cross-sectional areas are circular arc segments spaced apart in parallel.

15. The spray head as claimed in claim 9, wherein positional locking is effected on a high-pressure side.

16. The spray head as claimed in claim 9, wherein the exchangeable nozzle is held in the installed state in the bore by an external holding screw, wherein the holding screw is screwed into the bore of the nozzle carrier, wherein the holding screw, at a screw bottom against which the exchangeable nozzle directly bears, is conically configured, and wherein the exchangeable nozzle, in a screw seat of the screw bottom, is likewise of correspondingly conical configuration.

17. The spray head as claimed in claim 11, wherein the flank angle differs from the included angle by no more than about 3°.

18. The spray head as claimed in claim 11, wherein the flank angle differs from the included angle by no more them about 1°.

19. The spray head as claimed in claim 9, wherein the annular surface defines an annular line.
